(19) United States
(12) Patent Application Publication
(10) Pub. No.: US 2020/0195291 A1
(43) Pub. Date: Jun. 18, 2020

(54) Adjustable Cell Phone Case

(71) Applicant: Martin Roy Devoe, Las Vegas, NV (US)

(72) Inventor: Martin Roy Devoe, Las Vegas, NV (US)

(73) Assignee: MDR-X-INDISTRIES .LLC/MDR-X®, Las Vegas, NV (US)

(21) Appl. No.: 16/222,306

(22) Filed: Dec. 17, 2018

(51) Int. Cl. H04B 1/3888; A45C 11/00

(52) U.S. Cl. CPC H04B 1/3888; A45C 2011/002; A45C 11/00

(57) ABSTRACT

A cell phone cases that the user can expand or adjust to fit different size phones by having male and female parts that are design to inserted or attached to one another and allows part(s) to move dependent or independent from one another up, down, forward and backwards allowing the device to expand or adjust its size of the phone in length and width. When part(s) are moved up and down the user is expanding or adjusting the length of the device and when part(s) are moved forward and backwards the user is expanding or adjusting width of the device.

### FIELD OF THE INVENTION

This present invention is relates to a [Cell Phone Case]

### PROBLEM/BACKGROUND

The problem with cell phone cases they don't fit all size cell phones.

### SOLUTION/SUMMARY

A cell phone cases that can be adjusted to fit all different size cell phones.

### BRIEF DESCRIPTION OF THE DRAWINGS

FIG. 1: View of the device fully assembled.

FIG. 2: Top View of the device fully assembled.

FIG. 3: Under View of the device fully assembled.

FIG. 4: Lacking Arms.

FIG. 5: Platform Housing.

### DETAILED DESCRIPTION

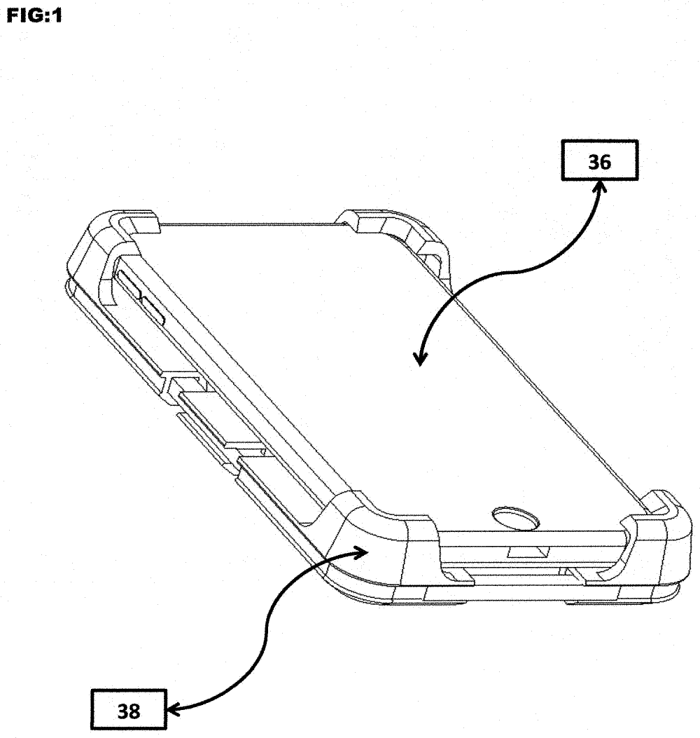

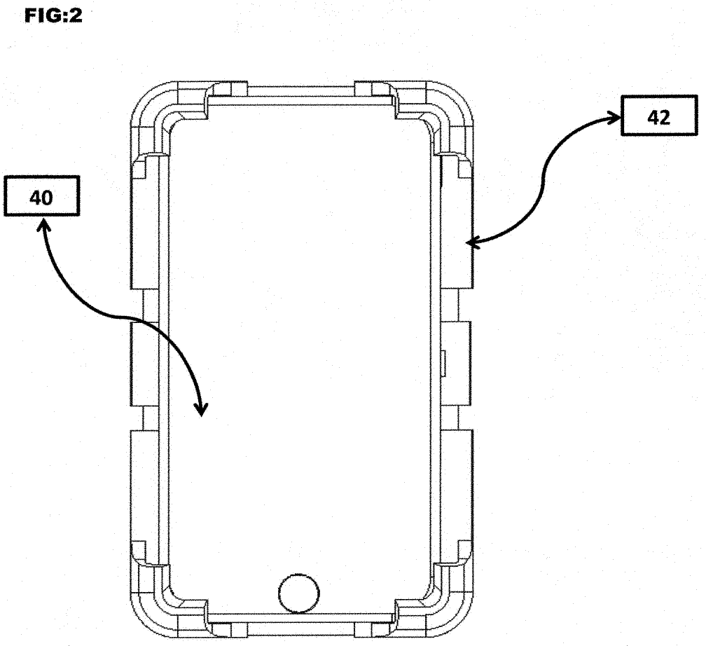

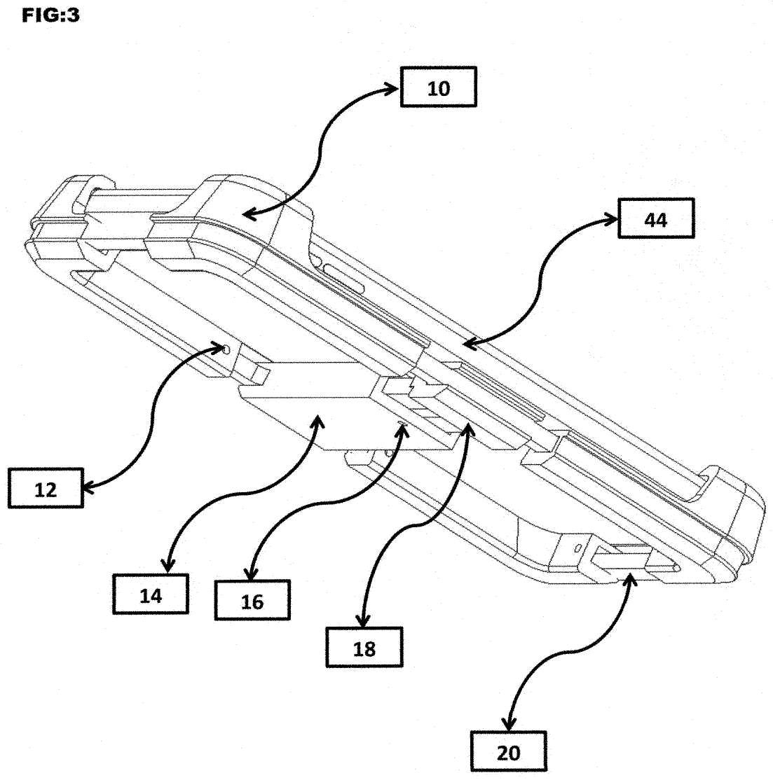

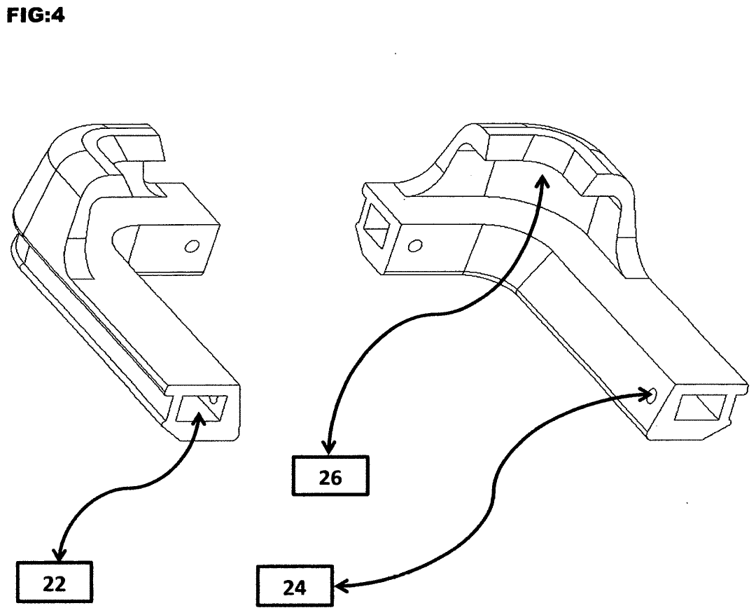

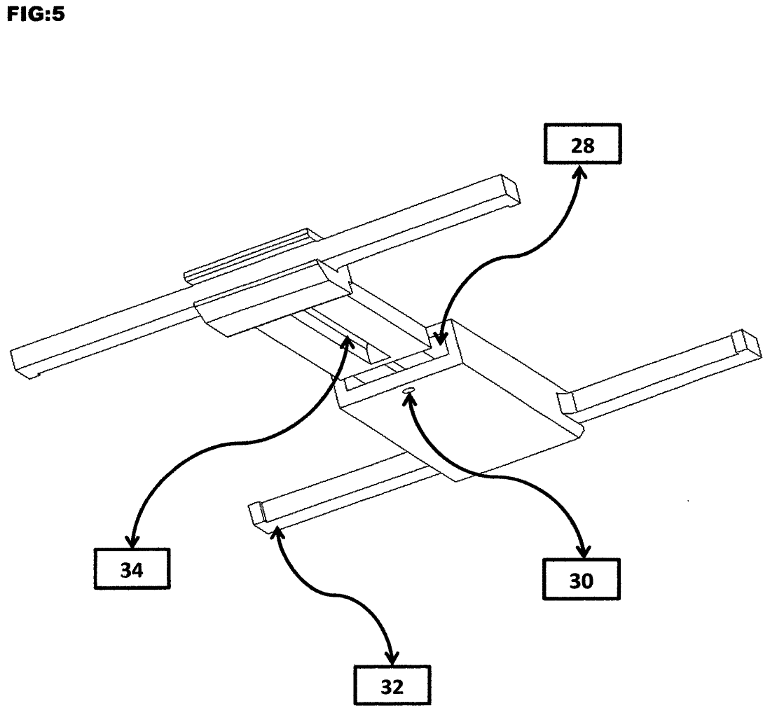

Referring to FIG. 1: A View of the device fully assembled with cell phone. 36. The cell phone attached to the device. 38. The device with the cell phone attached to it.
Referring to FIG. 2: A Top View of the device fully assembled with cell phone. 40. The cell phone attached to the device. 42. The device with the cell phone attached to it.
Referring to FIG. 3: 10. The Locking Arms are used to secure and lock the attended electronic device the locking arms are design to interlock to both the female and male platform housing guide tracks there are opening it each end of the locking arms the arms are shaped into an L (See FIG. 4). #12 The screw port is used to place a set screw to secure the locking arms to the platform housing guide tracks well still allowing the part to have the ability to move. There are two parts to the platform housing the female and male these two parts are made to interlock into one another given the parts the ability to move #14 is the female platform and #18 is the male platform. #16 Is a screw port that is use to secure the female platform to male platform well still allowing the parts to have the ability to move. #20 Top Rails these parts is use to attach accessories to the device. #44 Is the attended electronic device.
Referring to FIG. 4: 22. that opening is use to attach the arms to the female or male platform housing guide tracks (See FIG. 5 #32) the opening it the shorter end of the arms are use to attach a part called the top rails (See FIG. 3 #20) this part is use to attach accessories to the device. It the curved end of the locking arms it is raised #26 to forum a pocket that is used to secure the attended electronic device to the device the curved end haves a slight overhang that helps with securing attended electronic device. The longer end of the locking arms there is a screw port #24 that is used to place a set screw to secure the locking arms on to the platform housing guide tracks well still allowing the part to have the ability to move.
Referring to FIG. 5: There are two parts to the platform housing the female and male these two parts are made to be inserted or attached into one another well allowing the part to have the ability to move the female is on the lift side of the fig and the male is on the right side of the fig (See FIG. 5). Both male and female platform housing parts have guide tracks #32 that are use to interlock on to the locking arms it the end of each track there his a protrusion that is use to catch on to set screw that is placed in the screw port it the end of the long end of the locking arms (See FIG. 4 #24) to keep locking arms attached to male and female platform housing guide tracks. The male platform his a tell that is use to interlock into the female part this part also have a track cut into it #34 that is used to lock the male part to the female part while still allowing the part to move. The female platform his an opening #28 that allows the male platform to interlock on to female platform while still allowing the parts to move. The female platform his a screw port that is use for a set screw to keep both parts of the platform housing secured to each other the track that is cut into the male platform housing allows set screw to secured both parts of the well allowing the part to have the ability to move.

1. A cell phone cases that the user can expand or adjust to fit all different size phones that have parts that are designed to insert or attach to one another and allows the part(s) to move dependent or independent from one another.

2. A cell phone cases as set forth in claim-1, By having male and female parts the male parts are designed to be inserted or attached to the female parts and the female parts are designed to allow male parts to be inserted or attached to them. The guide tracks that are on both sides of the male and female parts allows the locking arms (female parts) to be inserted or attached to the guide tracks while still allowing part(s) to be able to move dependent or independent from one another.

3. A cell phone cases as set forth in claim-1, That have male and female parts that designed to be inserted or attached to one another and allows part(s) to move dependent or independent up, down, forward and backwards allowing the device to expand or adjust its size of the phone in length and width. When part(s) are moved up and down the user is expanding or adjusting the length of the device and when part(s) are moved forward and backwards the user is expanding or adjusting width of the device.
